(19) United States
(12) Patent Application Publication
(10) Pub. No.: US 2015/0161682 A1
(43) Pub. Date: Jun. 11, 2015

(54) VIRTUALIZING BUILDINGS/SITES AND AUGMENTING VIRTUALIZED BUILDINGS/SITES METHODS AND APPARATUSES

(71) Applicant: TollShare, Inc., Danville, CA (US)

(72) Inventors: Murali M. Karamchedu, Portland, OR (US); Ravi Asnani, Los Angeles, CA (US); Sanjay Nambiar, Los Angeles, CA (US)

(73) Assignee: TollShare, Inc., Danville, CA (US)

(21) Appl. No.: 14/103,657

(22) Filed: Dec. 11, 2013

(51) Int. Cl. G06Q 30/02

(52) U.S. Cl. CPC G06Q 30/0277

(57) ABSTRACT

Apparatuses, methods and storage medium associated with virtualizing a building or a site are disclosed herein. In embodiments, an apparatus for virtualizing a building or a site may include one or more processors, and a building/site interface engine configured to be operated by the one or more processors. The building/site interface engine may be configured to facilitate a representative of a building or site to logically associate a virtual billboard with the building or site, to enable an appearance of the corresponding building or site in a 3D view map be augmented with the virtual billboard. The virtual billboard may include one or more commercials. The 3D view map may include an image of the building or site. Other embodiments may be described and/or claimed.

### TECHNICAL FIELD

The present disclosure relates to the field of data processing, in particular, to apparatuses, methods and storage medium associated with virtualizing buildings or sites, including augmenting appearances of buildings or site in three dimensional (3D) view maps with virtual billboards having commercials.

### BACKGROUND

The background description provided herein is for the purpose of generally presenting the context of the disclosure. Unless otherwise indicated herein, the materials described in this section are not prior art to the claims in this application and are not admitted to be prior art by inclusion in this section.

Building or site owners, such as commercial building/site owners, like to maximize the profits they can earn from the buildings or the sites, while the sites await development. On the cost side, building owners have often employed technologies to reduce their operating costs. For examples, building owners have employed technologies to reduce their heat, ventilation and air conditioning (HVAC) cost, or their waste management cost. On the revenue side, in addition to interior space, building owners often lease out exterior or roof top spaces for signs or billboards. However, the potential is limited, as often, exterior signage is typically subject to restrictive local building ordinance or regulations. Little technologies have been applied to expand the opportunities of this revenue channel.

Advances in computing, networking and related technologies have led to proliferation of many popular online application services, including, but are not limited to, online map services, such as, Google Map or Bing Map, and in-vehicle/portable navigation systems. In recent years, some online map services and/or in-vehicle/portable navigation systems not only offer the traditional maps that are diagrammatic representations of the streets and roadways (possibly with building and landmark designations), but also 3D view maps, such as street view maps, that provide users with virtualized or actual 3D views of the streets, building, sites, and/or landmarks.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates an arrangement for virtualizing a building or a site, including augmenting appearances of buildings or sites in 3D view maps with virtual billboards, in accordance with various embodiments.

FIGS. 2 and 3 respectively illustrate an example user interface and process for logically associating a virtual billboard with a building or a site, in accordance with various embodiments.

FIGS. 4 and 5 respectively illustrate an example user interface and process for logically associating a commercial with a virtual billboard of a building or a site, in accordance with various embodiments.

FIG. 6 illustrates example processes for augmenting appearances of buildings or sites in 3D view maps with virtual billboards, in accordance with various embodiments.

FIG. 7 illustrates an example computing environment suitable for practicing the disclosure, in accordance with various embodiments.

FIG. 8 illustrates an example storage medium with instructions configured to enable an apparatus to practice the processes of the present disclosure, in accordance with various embodiments.

### DETAILED DESCRIPTION

Apparatuses, methods and storage medium associated with virtualizing a building or a site are disclosed herein. In embodiments, an apparatus for virtualizing a building or a site may include one or more processors, and a building/site interface engine configured to be operated by the one or more processors. The building/site interface engine may be configured to facilitate a representative of a building or site to logically associate a virtual billboard with the corresponding building or site, to enable an appearance of the building or site in a 3D view map be augmented with the virtual billboard. The virtual billboard may include one or more commercials. The 3D view map may include a virtualized or actual 3D view of the building or site. The 3D view map may, e.g., be a street view map that includes a view of a street segment where the building or site is located.

In embodiments, an apparatus for virtualizing a building or a site may include one or more processors, and a commercial engine configured to be operated by the one or more processors. The commercial engine may be configured to facilitate an advertiser or an agent of the advertiser to logically associate, unconditionally or conditionally, a commercial with a virtual billboard logically associated with a building or site, to enable an appearance of the building or site in a 3D view map be augmented with the virtual billboard having the commercial. The 3D view map may include a virtualized or actual 3D view of the building or site. The 3D view map may, e.g., be a street view map that includes a view of a segment of a street where the building or site is physically located.

In embodiments, an apparatus for virtualizing a building or site may include one or more processors, and a virtual billboard agent or module configured to be operated by the one or more processors. The virtual billboard agent or module may be configured to enable an appearance of a building or a site within a presentation of a 3D view map be augmented with a virtual billboard. The 3D view map may include a virtualized or actual 3D view of the building or site. The 3D view map may, e.g., be a street view map that includes a view of a street segment where the building or site is physically located. An example of the apparatus may be the client device itself, such as a smartphone, an in-vehicle/portable navigation system, having a map application and the virtual billboard agent. Another example of the apparatus may be an online map service server having a map service and the virtual billboard module.

These and other embodiments/aspects will be described in more detail below. In the description to follow, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “module” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

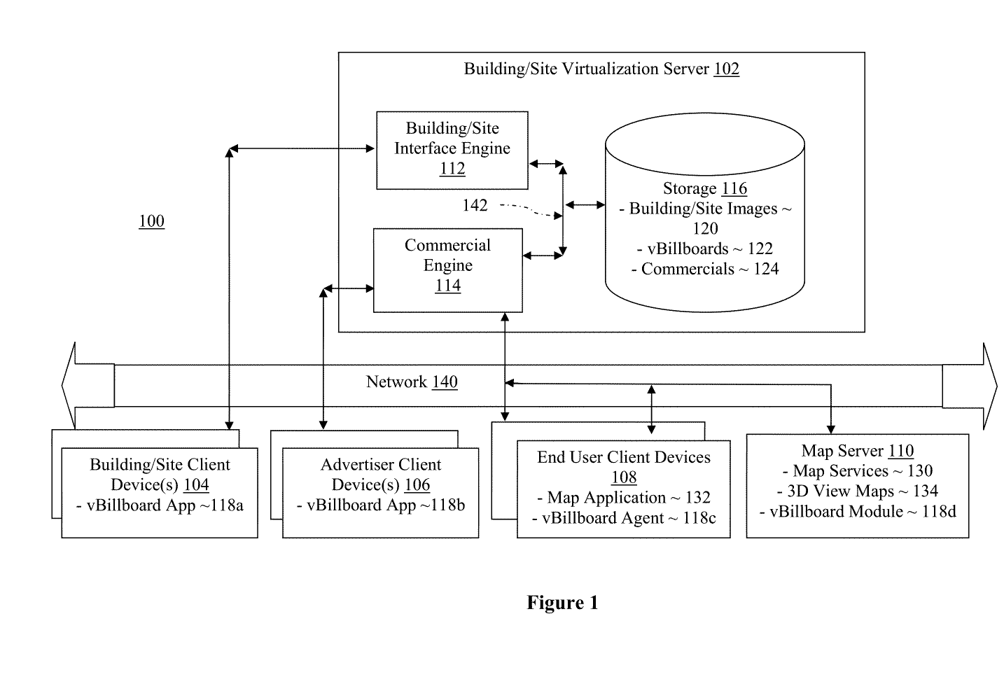

Referring now to FIG. 1, wherein an arrangement for virtualizing a building or a site, including augmenting appearances of buildings or sites in 3D view maps with virtual billboards, in accordance with various embodiments, is shown. As illustrated, for the embodiments, arrangement 100 may include building/site virtualization server 102, coupled with building/site client devices 104, advertiser client devices 106, end user client devices 108, and map server 110, via e.g., network(s) 140. Building/site virtualization server 102 may include building/site interface engine 112, commercial engine 114 and storage 116, coupled with each other, via, e.g., system bus(es) or network(s) 142. Building/site client devices 104 and advertiser client devices 106 may respectively include virtual billboard (vbillboard) application 118a and 118b. Further, at least one of end user client devices 108 and map server 110 may include vbillboard agent 118c or module 118d. As will be described in more detail below, together, building/site interface engine 112, commercial engine 114, vbillboard applications 118a-118b and vbillboard agent or module 118c/118d may be incorporated with teachings of the present disclosure to cooperate with each other to enable an appearance of a building or a site in a 3D view map be augmented with a vbillboard having one or more commercials. Virtual billboard (vbillboard) may be virtualization of any one of a number of physical billboards and/or signage. Each commercial may be an image or a multi-media content, with video and/or audio. As result, technologies may be applied to enable building/site owners to expand revenue opportunities for the external signage channel.

Building/site virtualization server 102 may be any one of a number of computer servers or collections of computing servers known in the art, available from companies, such as, but not limited to, Dell Computer of Austin Tex., or IBM of Armonk, N.Y. Each server may include one or more processors, memory, and peripheral devices. One or more of the processors may include multiple processor cores. In embodiments, when multiple computer servers are used, the computer servers may be organized into clusters, with the clusters coupled to one another through one or more, wired or wireless, local or wide area, private and/or public networks.

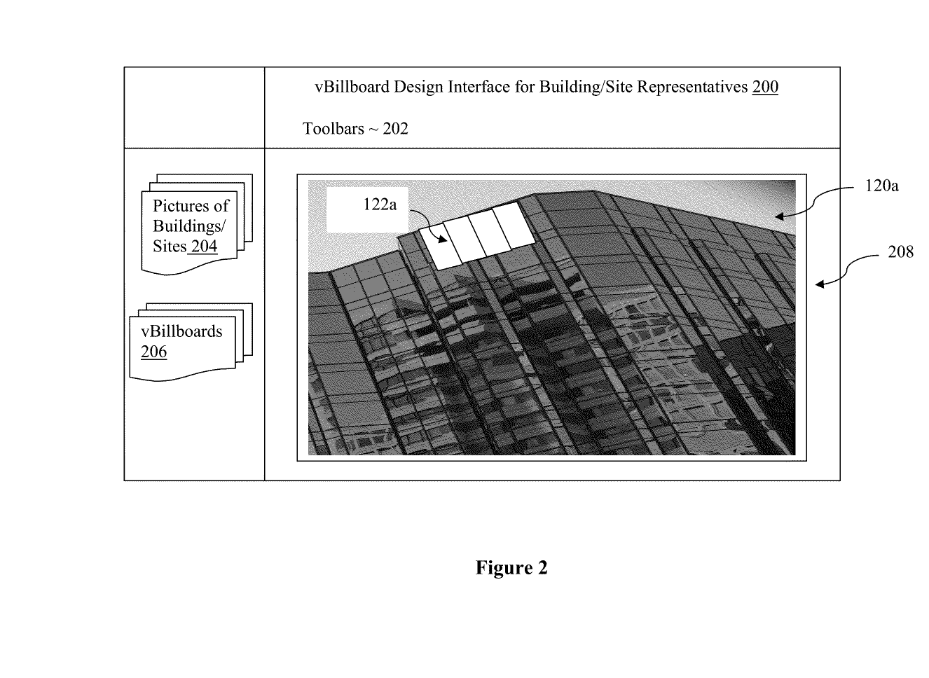

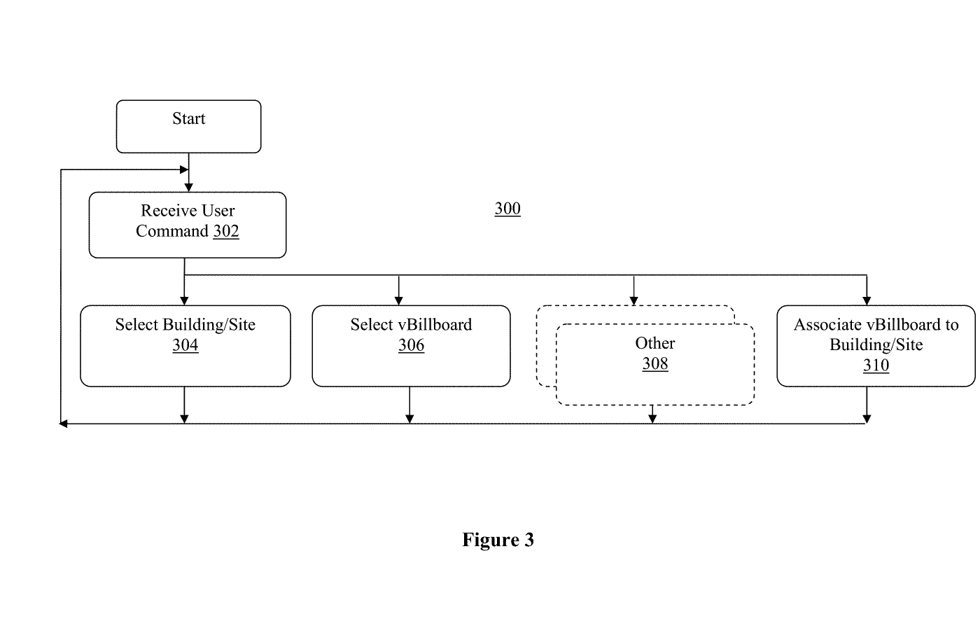

Building/site interface engine 112 may be configured to enable a representative of a building or a site to associate one or more vbillboards with the corresponding building or site. As described earlier, the term “virtual billboard,” or its short form “vbillboard,” as used herein, refers to virtualized versions of a wide range of physical billboards and/or signage. Examples of the user interface and the process for associating one or more vbillboards with a building will be further described below with references to FIGS. 2 and 3.

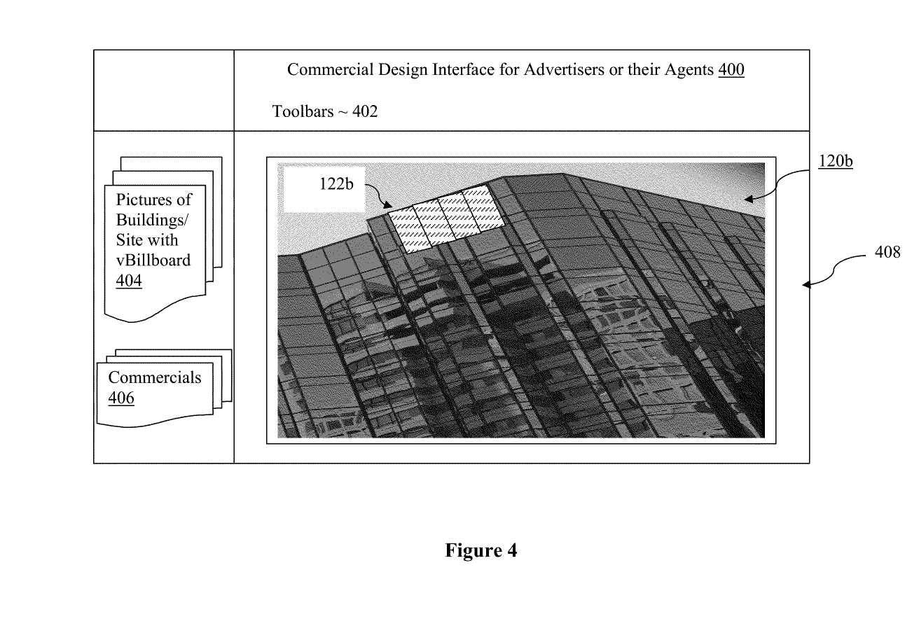

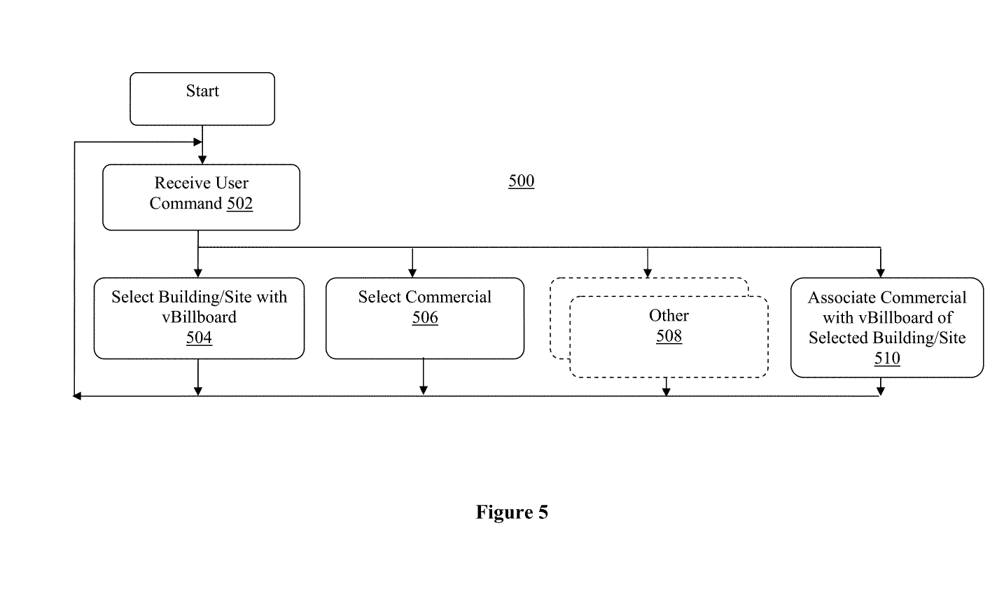

Commercial engine 114 may be configured to enable an advertiser or an agent of the advertiser to associate one or more commercials with one or more vbillboards of one or more buildings or sites. As described earlier, the term “commercials” may refer to an image or a silent video, or a multi-media content, such as a video with accompanying audio. Examples of the user interface and the process for associating one or more commercials with one or more vbillboards of one or more buildings or sites will be further described below with references to FIGS. 4 and 5.

Storage 116 may be configured to store building or site images 120, vbillboards 122, commercials 124 and/or accounting data 126. Accounting data 126 may include identifications of the building or site owners, advertisers or its agents, and financial data associated with billing advertisers and compensating the building or site owners, for the commercial services offered by the building or site owners through vbillboards associated with their buildings or sites. Accounting data 126 may also include identifications of the map services providers and financial data associated with billing the map services providers, for the virtualization and/or commercial services offered by building/site virtualization server 102. Storage unit 116 may be any one of a number of magnetic, electrical, optical, or solid state persistent mass storage units known in the art. One or more of the storage units may also include volatile memory for caching the data input/output operations.

System buses, if employed, coupling building/site interface engine 112, commercial engine 114 and storage 116 may be any one of a number of buses known in the art including, but are not limited to, Peripheral Component Interconnect (PCI) buses, or Universal Serial Bus (USB). Local or wide area network, if employed, coupling building/site interface engine 112, commercial engine 114 and storage 116 may be any one of a number of local or wide area networking technologies known in the art including, but are not limited to, Ethernet, WiFi, WiMAX, 3G/4G/5G, and so forth.

Building/site client devices 104 and advertiser client devices 106 may be any one of a number of stationary and/or mobile computing devices known in the art, including, but are not limited to, smartphones, computing tablets, laptop computers or desktop computers. Virtual billboard (vbillboard) applications 118a and 118b may be respectively configured to enable a representative of a building or a site, or an advertiser (or its agent) to interact with building/site interface engine 112 or commercial engine 114. Virtual billboard (vbillboard) applications 118a and 118b may be standalone applications or web applications executed or operated using a browser.

Similarly, end user client devices 108 may likewise be any one of a number of stationary and/or mobile computing devices known in the art, including, but are not limited to, smartphones, in-vehicle/portable navigation systems, computing tablets, laptop computers or desktop computers. Each end user client device 108 may further include map application 132. Map application 132 may be configured to interact with map services 130 of map servers 110 to provide map services to end users of client devices 108, including, but are not limited to, provision of 3D view maps 134, such as street view maps. Map application 132 may be a standalone application or a web application operated through a browser. In addition, each end user client device 108 may include vbillboard agent 118c. Virtual billboard (vbillboard) agent 118c, if provided, may be configured to identify an appearance of a building or site in a 3D view map, and augment the appearance with a vbillboard having a commercial rendered thereon. Virtual billboard (vbillboard) agent 118c may likewise be a standalone application or a browser plug-in.

Map servers 110, like building/site virtualization server 102, may any one of a number of servers known in the art, optionally organized into a network of connected clusters. Map servers 110 may include map service 130 configured to provide map services to end users of client devices 108, including, but are not limited to, provision of 3D view maps 134. In addition, map servers 110 may include vbillboard module 118d. Similar to vbillboard agent 118c, vbillboard module 118d, if provided, may be configured to identify an appearance of a building or site in a 3D view map, and augment the appearance with a vbillboard having a commercial rendered thereon. Virtual billboard (vbillboard) module 118d may be a standalone application.

Network 140 may include any combination of any number of wired or wireless, local or wide area, private and/or public networks. Wired local networks, may include, e.g., but are not limited to, Ethernet networks. Wireless local area networks, may include, e.g., but are not limited to, Wi-Fi networks. Wireless wide area networks, may include, e.g., but are not limited to, WiMax or 3G/4G/5G networks. Private networks may include, e.g., but are not limited to, enterprise networks. Public networks, may include, e.g., but is not limited to the Internet. It would be appreciated that at the each of the server or client device end, networks 140 may include one or more local area networks with gateways and firewalls, through which the respective client devices 104-108 and servers 102 or 110 go through to communicate with the other client devices 104-108 and servers 102 or 110. In between the device ends, there may be any number of network routers, switches and other networking equipment of the like. However, for ease of understanding, these gateways, firewalls, routers, switches, base stations, access points and the like are not shown.

Building/site interface engine 112, commercial engine 114, virtual billboard (vbillboard) applications 118a and 118b, vbillboard agent 118c or module 118d, and map services application 130 and agent 132 may be implemented in the native instructions of the underlying processors or in high level languages with compiler support to compile the high level languages into instructions of the instruction set architecture of the underlying processors. 3D view maps 134 may be encoded in accordance with any one of a number of image encoding schemes known in the art, including, but are not limited to, Joint Photographic Experts Group (JPEG).

Referring now to FIGS. 2 and 3, wherein an example user interface, and process for logically associating a virtual billboard with a building or a site, in accordance with various embodiments, are illustrated. As shown in FIG. 2, example user interface 200 for a representative of a building or a site to logically associate a vbillboard with a corresponding building or site may include a toolbar 202 with various tool icons (not shown) for various tools supported by building/site interface engine 112 to assist the representative in performing the logical association. For example, in embodiments where building/site virtualization server 102 may include a number of pre-collected images of buildings or sites, including the buildings/sites' identifications and addresses, the tool icons may include a tool icon for invoking a search facility to search for the image or images of a building or site, by its identification or address. Example user interface 200 may also present the buildings/sites with pre-existing images in the form of an expandable/collapsible list 204. In other embodiments, building/site interface engine 112 may be configured to support a representative of a building or site to import one or more images of the building or site. For the embodiments, the tool icons may include a tool icon for invoking an import facility to import an image or images of a building or site, and provide its identification and/or address.

In embodiments, building/site virtualization server 102 may include a number of pre-designed vbillboards 122. For these embodiments, the tool icons may include a tool icon for invoking a search facility to search for particular vbillboards 122. Example user interface 200 may also present vbillboards 122 in the form of an expandable/collapsible list 206. In other embodiments, building/site interface engine 112 may be configured to support a representative of a building or site importing his/her own vbillboard 122. For the embodiments, the tool icons may include a tool icon for invoking an import facility to import one or more vbillboards 122 to be associated with a building or site, and provide their identifications and/or descriptions.

Further, example user interface 200 may include a main display area or pane 208, where virtualization of the logical association of a vbillboard 122a with a building 120a (or a site) may be visualized for the representative. In embodiments where building/site interface engine 112 is configured to support particular placement of an associated vbillboard 122a with a building 120a (or a site), the tool icons may include a number of tool icons for moving vbillboard 122a around within pane 208, and/or zooming in or zooming out on an image of building 120a (or a site). Still further, the tool icons of example user interface 200 may include an icon for logically associating or binding a selected vbillboard 122a with a selected building 120a (or a selected site).

The functions and the tool icons described herein are illustrative, and not to be construed as limiting. The present disclosure may be practiced with more or less functions having more or less tool icons for invoking the functions. For examples, building/site interface engine 112 may additionally be configured with a registration function to register a building or site, including, but not limited to, the building/site's description and address, the contact information of the representative, and so forth. Building/site interface engine 112 may also be configured with an accounting function to compensate the building/site owners for commercials placed or played on vbillboards 122 of their buildings/sites.

As illustrated in FIG. 3, process 300 for associating a vbillboard 122 with a building or a site may include operations in blocks 302-310. The operations may be performed by, e.g., earlier described building/site interface engine 112, which as described, may be implemented in the native instructions of the underlying processor or in high level languages with compiler support to compile the high level languages into the native instructions. In other embodiments, all or part of building/site interface engine 112 may be implemented in hardware, e.g., in ASIC or programming a programmable integrated circuit, such as a Field Programmable Gate Array (FPGA).

Process 300 may start at block 302, where a user command may be received, e.g., from a representative of a building/site interacting with user interface 200. From block 302, process 300 may proceed to any one of blocks 304-310, depending on the user command received. In particular, process 300 may proceed from block 302 to block 304, and have a building/site selected, in response to a user command to select a building/site (e.g., from list 204). Process 300 may also proceed from block 302 to block 306, and have a vbillboard 122 selected, in response to a user command to select a vbillboard 122 (e.g., from list 206). Process 300 may also proceed from block 302 to block 310, and have a selected vbillboard 122a logically associated or bounded to a selected building/site, in response to a user command to associate the selected vbillboard 122a with the selected building/site.

Between selections and binding the selections, process 300 may proceed from block 302 to block 308, in response to one of the other user commands, e.g., zooming in or zooming out on the image 120a of selected building/site, moving around a selected vbillboard 122a, and so forth. At block 308, the user command may be processed and responded to accordingly, including responding and informing an user that the user command is invalid.

From any one of blocks 304-310, process 300 may return to block 302, where another user command may be received. On receipt of another user command, process 300 may repeat itself as earlier described. Eventually, process 300 may end, when a user command to terminate the session to select and associate a vbillboard 122 with a building/site is received.

FIGS. 4 and 5 respectively illustrate an example user interface and process for logically associating a commercial with a virtual billboard of a building or a site, in accordance with various embodiments. As shown in FIG. 4, example user interface 400 for an advertiser or an agent of an advertiser to logically associate a commercial with a vbillboard 122 of a building/site may include a toolbar 302 with various tool icons (not shown) for various tools supported by commercial engine 114 to assist the advertiser/agent in performing the association. For example, the tool icons may include a tool icon for invoking a search facility to search for the image or images 120 of a building/site with associated vbillboard 122, by the building/site's identification or address. Example user interface 400 may also present the buildings 120 with associated vbillboard 122 in the form of an expandable/collapsible list 404.

Additionally, the tool icons may include a tool icon for invoking an import facility to import one or more commercials 124 to be associated with a billboard 122 of a building/site, and provide their identifications and/or descriptions. When supported by commercial engine 114, example user interface 400 may also present the imported commercials 124 in the form of an expandable/collapsible list 406.

Further, example user interface 400 may include a main display area or pane 408, where the association of a commercial (denoted by the hash marks) with a vbillboard 122b of a building/site may be visualized for the advertiser/agent. In embodiments where commercial engine 112 is configured to support varying viewing of a commercial associated with a vbillboard 122b of a building/site, the tool icons may include a number of tool icons for zooming in or zooming out on image 120b of building/site with the associated vbillboard 122b having the commercial. Still further, the tool icons of example user interface 400 may include an icon for logically associating or binding a selected commercial 124b with vbillboard 122b of a building/site.

As noted earlier, the functions and the tool icons described herein are illustrative, and not to be construed as limiting on the present disclosure. The present disclosure may be practiced with more or less functions having more or less tool icons for invoking the functions. For examples, commercial engine 114 may be configured with a registration function to register an advertiser or an advertising agent, including, but not limited to, the advertiser/agent's identification and address, and so forth. Commercial engine 114 may be configured with an accounting function to invoice the advertisers or their agents, or the operator of map server 110 for commercials placed or played on vbillboards 122 of various buildings 120.

As illustrated in FIG. 5, process 500 for associating a commercial 124 with a vbillboard 122 of a building or a site may include operations in blocks 502-510. The operations may be performed by, e.g., earlier described commercial engine 114, which as described, may be implemented in the native instructions of the underlying processor or in high level languages with compiler support to compile the high level languages into the native instructions. In other embodiments, all or part of commercial engine 114 may be implemented in hardware, e.g., in ASIC or programming a programmable integrated circuit, such as a Field Programmable Gate Array (FPGA).

Process 500 may start at block 502, where a user command may be received, e.g., from an advertiser or an agent of the advertiser interacting with user interface 400. From block 502, process 500 may proceed to any one of blocks 504-510, depending on the user command received. In particular, process 500 may proceed from block 502 to block 504, and have a building/site with vbillboard 122b selected, in response to a user command to select a building/site with vbillboard 122 (e.g., from list 404). Process 500 may also proceed from block 502 to block 506, and have a commercial 124 selected, in response to a user command to select a commercial 124 (e.g., from list 406).

Process 500 may also proceed from block 502 to block 510, and have a selected commercial 124 logically associated or bounded to a selected building/site with vbillboard 122b, in response to a user command to associate the selected commercial 124 with the selected buildingsite with vbillboard 122b. In embodiments, process 500 may allow the selected commercial 124 to be conditionally or unconditionally associated with the selected building/site with vbillboard 122b. For conditional association, operations at block 510 may allow the advertiser/agent to specify the conditions of association. Examples of conditions of association may include, but are not limited to, the targeted demographics and/or interests of the end users of client devices 108, and/or locations of client devices 108. An unconditional association may result in the selected commercial 124 be unconditionally placed or played on vbillboard 122b of building/site, whenever a 3D view map 134 having an image 120b of the building/site is presented on an end user client device 108. Whereas, for a conditional association, the selected commercial 124 may be placed or played on vbillboard 122b of a building/site in a 3D view map 134, when the 3D map is presented on an end user client device 108 that meets the specified condition(s) (targeting criteria).

Between selection and binding the selection, process 500 may proceed from block 502 to block 508, in response to one of the other user commands, e.g., zooming in or zooming out on the image 120b of the selected building/site, and so forth. At block 508, the user command may be processed and responded to accordingly, including responding and informing an user that the user command is invalid.

From any one of blocks 504-510, process 500 may return to block 502, where another user command may be received. On receipt of another user command, process 500 may repeat itself as earlier described. Eventually, process 500 may end, when a user command to terminate the session to select and associate a commercial 124 with a building/site having a vbillboard 122b is received.

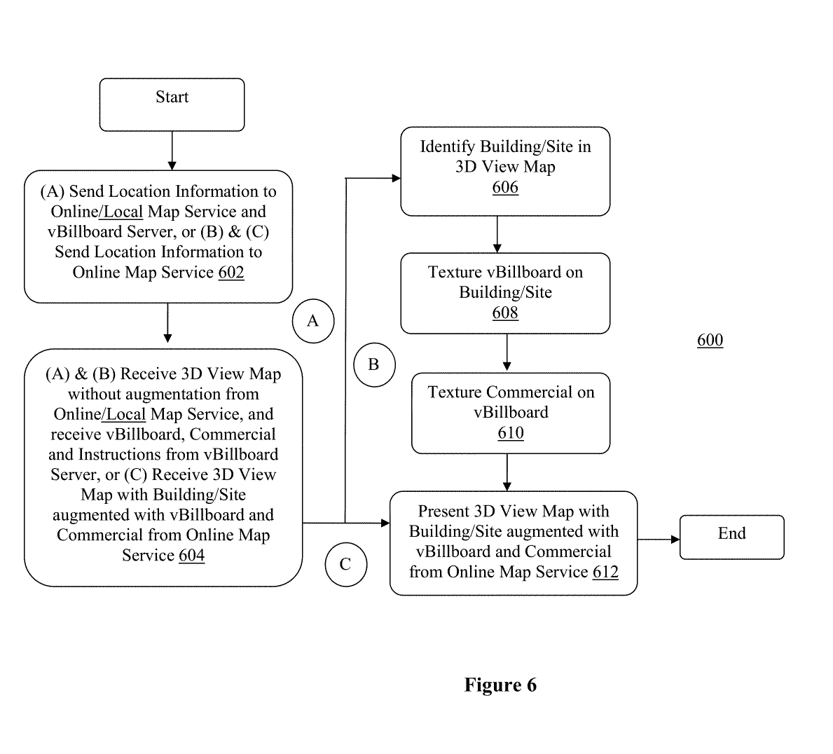

Referring now to FIG. 6, wherein an example process for augmenting an appearance of a building or a site in a 3D view map with a virtual billboard, in accordance with various embodiments. As shown, process 600 may include, in some embodiments (groups A and B), operations in blocks 602-612, and in other embodiments (group C), operations in blocks 602-604, and 612. For embodiments of either group A, B or C, the operations in blocks 602-604 may be performed, e.g., by vbillboard agent 118c of end user client device 108. For embodiments of groups A and B, operations of blocks 608-610 may also be performed by vbillboard agent 118c of end user client device 108. For embodiments of group C, where operations of blocks 608-610 are not performed by end user client device 108, the operations of blocks 608-610 may be performed by vbillboard module 118d of map server 110 instead.

For the embodiments of group A, at block 602, the current location of end user client device 108 may be transmitted to, e.g., map services 130 of map server 110, or to a local map service of an in-vehicle/portable navigation system, to request a 3D view map 134, to be provided in view of the current location. Additionally, the current location of end user client device 108 may also be transmitted to, e.g., commercial engine 114 of building/site virtualization server 102, to cause the provision of vbillboard 122 and commercial 124 associated with buildings/sites in the to be provided 3D view map 134. From block 602, process may proceed to block 604. At block 604, the requested 3D view map 134, as well as the vbillboards 122 and commercials 124 associated with the buildings/sites in the 3D view map 134 may be received.

From block 604, process 600 may proceed to blocks 606-610. At block 606, the 3D view map 134 may be analyzed to identify the appearances of the buildings/sites. The identification may be performed using any one of a number of object recognition techniques. Examples of object recognition techniques may include, but are not limited to, appearance based methods, such as, edge matching, gradient matching and so forth, or features based methods, such as, interpretation trees, pose consistency, and so forth. At block 608, the identified appearances of buildings/sites may be augmented with one or more associated vbillboards 122, using any one of a number of graphical techniques, e.g., texturing. At block 610, one or more commercials 124 may be correspondingly placed or played the vbillboards 122. The placement or play may likewise be effectuated via any one of a number of graphical techniques, e.g., texturing.

From block 610, process 600 may proceed to block 612. At block 612, the 3D view map with appearances of buildings/sites inside the map augmented with vbillboards 122 having commercials 124 may be presented on a display device of end user client device 108. Additionally, as client device 108 changes its location, orientation, and/or direction of travel, process 600 may adapt the augmentation of vbillboards 122 having commercials 124 on the buildings/sites, as the 3D view map is adapted.

For the embodiments of group B, the operations in blocks 602-612 are similar to those of the embodiments of group A, except at block 602, the current location of end user client device 108 may be provided to map services 130 of map server 110, without providing the current location to commercial engine 114 of building/site virtualization server 102. For these embodiments, the current location of end user client device 108 may be provided to commercial engine 114 of building/site virtualization server 102 by map services 130 of map server 110 instead. From thereon, the operations of blocks 604-612 may be the same as the embodiments of group A.

For the embodiments of group C, as described earlier, the operations of blocks 606-610 are not performed by end user client device 108. Instead, map services 130 of map server 102 may cooperate with commercial engine 114 of building/site virtualization server 102 to obtain the vbillboards 122 and commercials 124 associated with buildings 120 in real time or in advance. On receipt of the vbillboards 122 and commercials 124 associated with the buildings/sites, vbillboard module 118d may perform the operations of blocks 606-610, as earlier described. Thus, for these embodiments, when 3D view maps 134 are provided from map server 110 to end user client device 108, appearances of buildings/site with 3D view maps 134 have already been augmented with vbillboards 122 having commercials 124, if appropriate.

Thus, for the embodiments of group C, at block 602, the current location of end user client device 108 may be transmitted to, e.g., map services 130 of map server 110, to request a 3D view map 134, to be provided in view of the current location. From block 602, process may proceed to block 604. At block 604, the requested 3D view map 134 with appearance of buildings/site within the 3D view map already augmented with vbillboards 122 and commercials 124 may be received.

From block 604, process 600 may proceed directly to block 612. At block 612, the 3D view map with appearances of buildings/sites inside the map textured with vbillboards 122 having commercials 124 may be presented on a display device of end user client device 108. Additionally, as client device 108 changes its location, orientation, and/or direction of travel, process 600 may adapt the texturing of vbillboards 122 having commercials 124, on buildings/sites, as the 3D view map 134 is adapted.

While for ease of understandings, embodiments of process 600 have been described with the various operations keyed of the current location of the client device. The description is not meant to limiting. In other embodiments, the various operations may be keyed of the directions of the client devices or planned routes of the client devices to anticipate when the client device will be proximally located near the building/sites with associated vbillboards. The 3D maps, the vbillboards and/or the commercials may be pre-fetched, pre-analyzed, and/or pre-integrated prior to the client devices actually arriving at the proximity of the building/site, triggering the rendering of the 3D map that includes appearances of the buildings/sites.

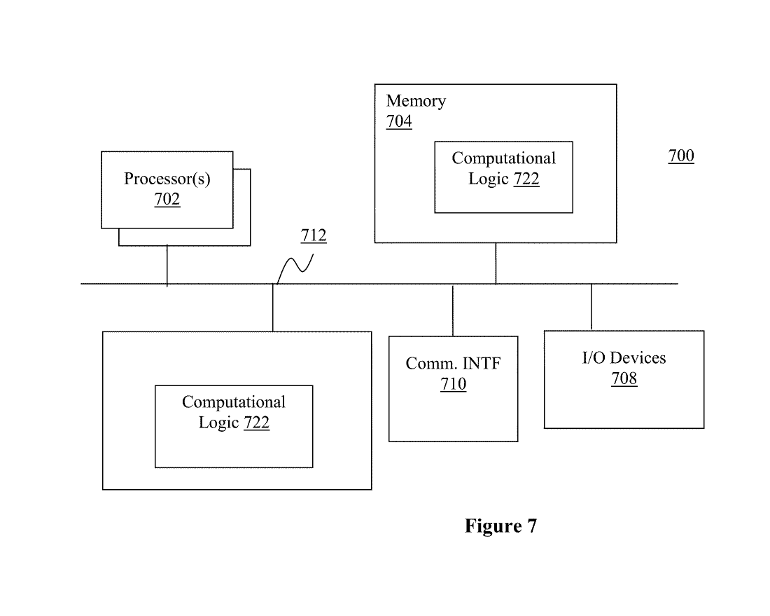

Referring now to FIG. 7, wherein an example computer suitable for use as either server 102, one of client devices 104-108, or server 110 of FIG. 1, in accordance with various embodiments, is illustrated. As shown, computer 700 may include one or more processors or processor cores 702, and system memory 704. For the purpose of this application, including the claims, the terms “processor” and “processor cores” may be considered synonymous, unless the context clearly requires otherwise. System memory 704 may include volatile and or non-volatile memory, including CAM. Additionally, computer 700 may include mass storage devices 706 (such as diskette, hard drive, compact disc read only memory (CD-ROM) and so forth), input/output devices 708 (such as display, keyboard, cursor control and so forth) and communication interfaces 710 (such as network interface cards, modems and so forth). The elements may be coupled to each other via system bus 712, which may represent one or more buses. In the case of multiple buses, they may be bridged by one or more bus bridges (not shown).

Each of these elements may perform its conventional functions known in the art. In particular, system memory 704 and mass storage devices 706 may be employed to store a working copy and a permanent copy of the programming instructions implementing the various operations earlier described, e.g., the operations associated with building/site interface engine 112, commercial engine 114, vbillboard applications 118a and 118b, vbillboard agent 118c and/or vbillboard module 118c, collectively denoted as computational logic 722. Computational logic 722 may be implemented with assembler instructions supported by processor(s) 702 or high-level languages, such as, for example, C, that can be compiled into such instructions.

The permanent copy of the programming instructions may be placed into permanent storage devices 706 in the factory, or in the field, through, for example, a distribution medium (not shown), such as a compact disc (CD), or through communication interface 710 (from a distribution server (not shown)). That is, one or more distribution media having an implementation of computational logic 722 may be employed to distribute computational logic 722 and program various computing devices.

The number, capability and/or capacity of these elements 710-712 may vary, depending on whether computer 700 is used as server 102/110 or a client device 104-108. When use as a client device 104-108, whether client device 102-108 is a stationary or mobile device, like a smartphone, in-vehicle/portable navigation system, computing tablet, ultrabook or laptop, with general or specific applications. The constitutions of these elements are otherwise known, and accordingly will not be further described.

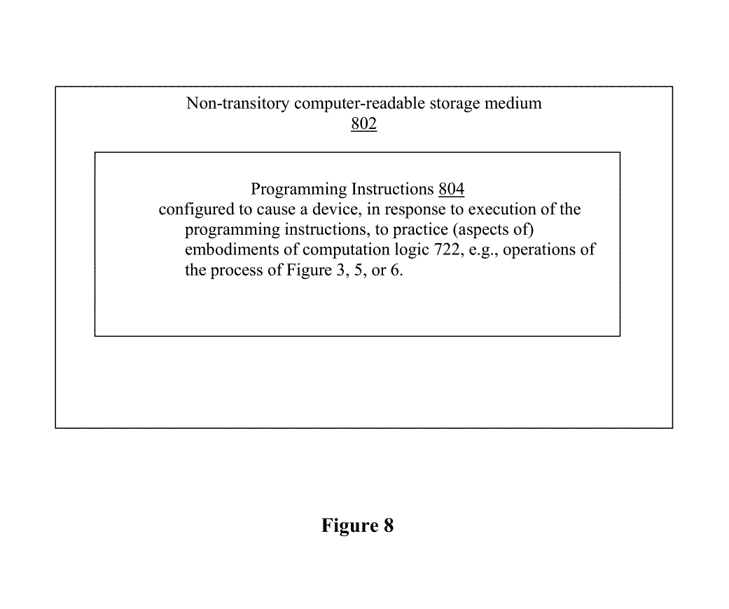

FIG. 8 illustrates an example computer-readable non-transitory storage medium having instructions configured to practice all or selected ones of the operations associated with building/site interface engine 112, commercial engine 114, vbillboard applications 118a and 118b, vbillboard agent 118c and/or vbillboard module 118c, earlier described; in accordance with various embodiments. As illustrated, computer-readable non-transitory storage medium 802 may include a number of programming instructions 804. Programming instructions 804 may be configured to enable a device, e.g., computer 700, in response to execution of the programming instructions, to perform various ones of the earlier described operations, e.g., various operations of process 300 of FIG. 3, process 500 of FIG. 5, or process 600 of FIG. 6. In alternate embodiments, programming instructions 804 may be disposed on multiple computer-readable non-transitory storage media 802 instead. In still other embodiments, programming instructions 804 may be disposed on computer-readable transitory storage media 802, such as signals.

Thus, the present disclosure applies multiple technologies in a novel manner to expand revenue opportunities for building owners. Technologies applied include, but are not limited, web based applications, online map services, augmented reality, objects recognition, and graphical techniques.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. Therefore, it is manifestly intended that embodiments described herein be limited only by the examples.

Where the disclosure recites “a” or “a first” element or the equivalent thereof, such disclosure includes one or more such elements, neither requiring nor excluding two or more such elements. Further, ordinal indicators (e.g., first, second or third) for identified elements are used to distinguish between the elements, and do not indicate or imply a required or limited number of such elements, nor do they indicate a particular position or order of such elements unless otherwise specifically stated.

What is claimed is:

1. An apparatus for virtualizing a building or a site, comprising:
one or more processors; and
a building/site interface engine configured to be operated by the one or more processors to facilitate a representative of a building or a site to logically associate a virtual billboard with the corresponding building or site, to enable an appearance of the corresponding building or site in a 3D view map be augmented with the virtual billboard, wherein the 3D view map comprises an image of the corresponding building or site.

2. The apparatus of claim 1, wherein the building/site interface engine is configured to be operated by the one or more processors to receive the virtual billboard from a device of the representative of the building or site.

3. The apparatus of claim 1, wherein the building/site interface engine is configured to be operated by the one or more processors to facilitate the representative in trying out logical associations of a plurality of virtual billboards with the building or site.

4. The apparatus of claim 3, wherein the building/site interface engine is configured to be operated by the one or more processors to present a plurality of virtual billboards for selection to be logically associated with the building or site.

5. The apparatus of claim 1, further comprising a commercial engine configured to be operated by the one or more processors to facilitate an advertiser or an agent of the advertiser to unconditionally or conditionally logically associate a commercial with the virtual billboard, to enable the appearance of the building or site in the 3D view map be augmented with the virtual billboard having the commercial.

6. The apparatus of claim 5, wherein the commercial engine is further configured to be operated by the one or more processors to receive the commercial from the advertiser or the agent of the advertiser, and indication of whether the commercial is to be unconditionally or conditionally logically associated with the virtual billboard.

7. The apparatus of claim 5, wherein the commercial engine is further configured to be operated by the one or more processors to facilitate the advertiser or the agent of the advertiser to in trying out a plurality of presentations of the 3D view map with appearances of buildings or sites respectively augmented with a plurality of virtual billboards having the commercial.

8. The apparatus of claim 7, wherein the commercial engine is configured to be operated by the one or more processors to present the advertiser or the agent of the advertiser with the plurality of virtual billboards of buildings or sites for selection.

9. The apparatus of claim 5, wherein the commercial engine is further configured to provide the virtual billboard and the commercial to a client device to augment the appearance of the building or site in a presentation of the 3D view map on the client device.

10. The apparatus of claim 9, wherein the commercial engine is further configured to be operated by the one or more processors to provide the virtual billboard and the commercial to the client device, in response to the client device receiving or requesting, or about to receive or request, for the 3D view map.

11. The apparatus of claim 9, wherein the commercial engine is further configured to be operated by the one or more processors to provide the virtual billboard and the commercial to the client device, in response to a determination that the client device is proximally disposed or about to be proximally disposed near the building or site.

12. The apparatus of claim 9, wherein the commercial engine is further configured to be operated by the one or more processors to receive a current location, a direction, or a planned route of the client device, and determine that the client device is or will be proximally disposed near the building or site, based at least in part on the current location, the direction or the planned route.

13. The apparatus of claim 5, wherein the virtual billboard is to be textured onto the appearance of the building or site within the 3D view map, and the commercial is to be textured onto the virtual billboard.

14. The apparatus of claim 5, wherein the commercial engine is further configured to provide the virtual billboard and the commercial to a map service server to enable the appearance of the building or site in a presentation of the 3D view map on a client device be augmented with the virtual billboard having the commercial.

15. An apparatus for virtualizing a building or site, comprising:
one or more processors; and
a commercial engine configured to be operated by the one or more processors to facilitate an advertiser or an agent of the advertiser to logically associate, unconditionally or conditionally, a commercial with a virtual billboard logically associated with a building or site, to enable an appearance of the building or site in a 3D view map be augmented with the virtual billboard having the commercial, wherein the 3D view map comprises an image of the building or site.

16. The apparatus of claim 15, wherein the commercial engine is further configured to be operated by the one or more processors to receive the commercial from the advertiser or the agent of the advertiser, and indication of whether the commercial is to be unconditionally or conditionally logically associated with the virtual billboard.

17. The apparatus of claim 15, wherein the commercial engine is further configured to be operated by the one or more processors to facilitate the advertiser or the agent of the advertiser to in trying out a plurality of presentations of the 3D view map with appearances of buildings respectively augmented with a plurality of virtual billboards having the commercial.

18. The apparatus of claim 17, wherein the commercial engine is configured to be operated by the one or more processors to present the advertiser or the agent of the advertiser with the plurality of virtual billboards of buildings or sites for selection.

19. The apparatus of claim 15, wherein the commercial engine is further configured to provide the virtual billboard and the commercial to a client device to augment the appearance of the building or site in a presentation of the 3D view map on the client device.

20. The apparatus of claim 19, wherein the commercial engine is further configured to be operated by the one or more processors to provide the virtual billboard and the commercial to the client device, in response to the client device receiving or requesting, or about to receive or request, for the 3D view map.

21. The apparatus of claim 19, wherein the commercial engine is further configured to be operated by the one or more processors to provide the virtual billboard and the commercial to the client device, in response to a determination that the client device is proximally disposed or about to be proximally disposed near the building or site.

22. The apparatus of claim 19, wherein the commercial engine is further configured to be operated by the one or more processors to receive a current location, a direction, or a planned route of the client device, and determine that the client device is or will be proximally disposed near the building or site, based at least in part on the current location, the direction or the planned route.

23. The apparatus of claim 15, wherein the virtual billboard is to be textured onto the appearance of the building within the 3D view map, and the commercial is to be textured onto the virtual billboard.

24. The apparatus of claim 15, wherein the commercial engine is further configured to provide the virtual billboard and the commercial to a map service server to enable the appearance of the building or site in a presentation of the 3D view map on a client device be augmented with the virtual billboard having the commercial.

25. An apparatus for virtualizing a building or site, comprising:
one or more processors; and
a virtual billboard agent or module configured to be operated by the one or more processors to enable an appearance of a building or a site within a presentation of a 3D view map on a client device be augmented with a virtual billboard, wherein the 3D view map includes an image of the building or site.

26. The apparatus of claim 25, wherein the apparatus comprises a client device, wherein the apparatus further comprises a map application configured to receive the 3D view map from an online map service via a network.

27. The apparatus of claim 26, wherein the map application is configured to provide the online map service with a current location of the client device.

28. The apparatus of claim 25, wherein the apparatus comprises a client device having the virtual billboard agent, and wherein the virtual billboard agent is configured to receive the virtual billboard, from an online virtual billboard service, identify an appearance of the building or site within the street view map, and texture the virtual billboard onto the appearance of the building or site within the 3D view map.

29. The apparatus of claim 28, wherein the virtual billboard agent is further configured to receive a commercial, from the online virtual billboard service or an online commercial service, and texture the commercial onto the virtual billboard of the building or site within the 3D view map.

30. The apparatus of claim 29, wherein the virtual billboard agent is further configured to adapt the texturing of the billboard and the commercial, in response to adaptations of the 3D view map by the map application.

31. The apparatus of claim 28, wherein the client device comprises a selected one of a smartphone, an in-vehicle or portable navigation system.

32. The apparatus of claim 25, wherein the apparatus comprises an online map service and the virtual billboard module, wherein the virtual billboard agent or module is configured to identify an appearance of the building or site within the 3D view map, and texture the virtual billboard onto the appearance of the building or site within the 3D view map, before the 3D view map is provided to the client device by the online map service.

33. The apparatus of claim 32, wherein the virtual billboard module is further configured to texture a commercial onto the virtual billboard of the building or site within the 3D view map, before the 3D view map is provided to the client device by the online map service.

34. The apparatus of claim 33, wherein the virtual billboard module is further configured to adapt the texturing of the billboard and the commercial, in response to adaptations of the 3D view map by the online map service in view of changing location or orientation of the client device.

35. At least one storage medium comprising a plurality of instructions configured to cause a computing device, in response to execution of the instructions by the computing device, to:
facilitate a representative of a building or a site to logically associate a virtual billboard with the corresponding building or site, to enable an appearance of the corresponding building or site in a 3D view map be augmented with the virtual billboard;
facilitate an advertiser or an agent of the advertiser to logically associate, unconditionally or conditionally, a commercial with the virtual billboard, to enable an appearance of the building or site in a 3D view map augmented with the virtual billboard, be further augmented with the commercial in the virtual billboard; or
enable an appearance of the building or a site within a presentation of a 3D view map on a client device be augmented with a virtual billboard and the commercial;
wherein the 3D view map comprises an image of the corresponding building or site.

36. A method for augmenting an appearance of a building, comprising:
facilitating a representative of a building or a site to logically associate a virtual billboard with the corresponding building or site, to enable an appearance of the corresponding building or site in a 3D view map be augmented with the virtual billboard;
facilitating an advertiser or an agent of the advertiser to logically associate, unconditionally or conditionally, a commercial with the virtual billboard, to enable an appearance of the building or site in a 3D view map augmented with the virtual billboard, be further augmented with the commercial in the virtual billboard; or
enabling an appearance of the building or a site within a presentation of a 3D view map on a client device be augmented with a virtual billboard and the commercial;
wherein the 3D view map comprises an image of the corresponding building or site.
